(19) United States
(12) Patent Application Publication
(10) Pub. No.: US 2012/0098373 A1
(43) Pub. Date: Apr. 26, 2012

(54) TORQUE SUPPORT

(75) Inventors: Gerd Kaspari, Coesfeld (DE); Walter Ribbers, Raesfeld Erle (DE); Andre Jagodowski, Velen (DE)

(73) Assignee: AS DRIVES & SERVICES GMBH, Reken, DE (DE)

(21) Appl. No.: 13/263,103

(22) PCT Filed: Mar. 11, 2010
(86) PCT No.: PCT/EP2010/053107

§ 371 Date: Dec. 23, 2011

(30) Foreign Application Priority Data
Apr. 6, 2009 (DE) 10 2009 003 747.0

(51) Int. Cl. H02K 5/22

(52) U.S. Cl. 310/91

(57) ABSTRACT

The invention relates to a torque support for motors, in particular drive motors, comprising at least one first and one second fixing unit that can be non-rotatably mounted to at least one first and one second motor and at least one connecting element between the first and the second fixing element. The invention is characterised in that the connecting element is designed to be moved at least in its longitudinal direction, in order to compensate differences in distance between the motors.

The invention relates to a torque support for motors, in particular drive motors.

Torque supports are known from the prior art. They are used to absorb a reaction torque. Torque supports are typically anchored on foundations provided specifically therefor or on the frame in order to introduce the absorbed reaction torque. In particular in gearless drive motors (also referred to as torque motors), anchoring on counterbearings outside the frame is usually not possible for reasons of space. For these reasons, only the attachment often remains on the frame.

The disadvantage of such an attachment of a torque support is however that either correspondingly sized counterbearings must be provided, depending on the power of the motor, or a stable seat which corresponds to the power must be formed on the frame. It is particularly problematic in this case that the effective forces act on the whole system. Possible consequences of this can be material fatigue, as a result of which extensive restoration measures must be taken. This leads not least to relatively long stoppage times of the affected machines and to higher costs.

Furthermore, both methods of fastening the torque supports have in common that sometimes very large counterbearings must be integrated in or on the system in order to absorb the effective forces, which limits the possibilities of a compact construction.

The object of the present invention is to alleviate the disadvantages known from the prior art at least partially.

It is in particular an object of the present invention to decouple the torque support at least partially from the other parts of the system, for example the frame, or to distribute the forces, within the spatial limits when torque motors are used.

The above object is achieved with a device according to the invention for coupling at least two motors according to claim 1. Preferred configurations of further embodiments form the subject matter of the subclaims.

According to the invention, the torque support for motors, in particular for drive motors, has at least one first and one second fixing unit for non-rotatable mounting on at least one first and one second motor and at least one connecting element between the first and second fixing units. The torque support according to the invention is characterised in that the connecting element is designed to be moved at least in its longitudinal direction in order to compensate differences in distance.

“Longitudinally movable” according to the present invention means a connecting element which can be adapted flexibly in relation to the distance between two drives.

The connecting element of the torque support according to the invention is according to a particularly preferred embodiment movable in a tilting and/or torsional manner. “Movable in a tilting manner” in this case means a connecting element which can in particular compensate differences in the parallel alignment of two drives and the axes thereof. “Movable in a torsional manner” further means a connecting element which can be twisted to a predefined degree along the direction of its main extent, at least on the basis of the design property thereof. It is inter alia not necessary for additional articulations to be provided, but that torsion is made possible due to the structure of the component and the elasticity provided thereby. Of course, it also lies within the meaning of the present invention that the longitudinal, tilting and torsional movability is not only provided by the connecting element but also in particular by the interaction with the fixing unit(s).

According to a further, particularly preferred embodiment, the connecting element of the torque support according to the invention provides a spherical compensation of movement between the drive motors connected thereby. “Spherical” within the meaning of the present invention means the extension or effect in the three spatial dimensions, wherefrom rotation about the axis/axes of the motor(s) is of course prevented.

According to a further, particularly preferred embodiment of the torque support according to the invention, the tilting movability is effected by a hinge, a clutch, an articulation or a combination thereof and the like.

The torque support according to the invention has, according to a further, particularly preferred embodiment, a segmented connecting element, the segments being connected by means of a coupling region. “Segmented” according to the present invention means preferably a three-dimensional configuration in the form of a milled portion, such as a groove, and/or a projection, such as a spring, and alternating combinations thereof. Of course, these segments are not limited to straight shapes within the meaning of the present invention, but can also have other line shapes, in particular those of circles and/or circular segments.

According to a further, particularly preferred embodiment of the torque support according to the invention, the coupling region of the segmented connecting element has a connector and a receiving region, wherein the connector is mounted in the receiving region in a longitudinally displaceable and/or rotationally movable manner and can be telescoped for this purpose.

According to a further, particularly preferred embodiment of the torque support according to the invention, the coupling region of the segmented connecting element is configured as a sliding clutch between at least one first and one second segment of the connecting element.

According to a further, particularly preferred embodiment of the torque support according to the invention, the coupling region of the segmented connecting element, which is configured as a sliding clutch, provides at least one longitudinally displaceable tongue and groove connection between the segments of the connecting element. According to a further, particularly preferred embodiment, the depth of the groove receiving the tongue is greater than that of the tongues. According to a further, particularly preferred embodiment, a profile is arranged, particularly replaceably, in the groove, which profile has in particular for its part a recess which directly receives the tongue.

According to a further, particularly preferred embodiment of the torque support according to the invention, the fixing unit is connected to the housing of the motor or to the stator thereof in a form-fitting and/or force-fitting and/or material manner and is in particular screw-fastened thereto.

According to a further, particularly preferred embodiment of the torque support according to the invention, the fixing unit is arranged on an end face of the motor and in particular has an annular configuration.

The torque support according to the invention has, according to a further, particularly preferred embodiment, a screw-fastening with a spring-elastic spacer element. This is used in particular to connect the fixing unit to the connecting element in an at least longitudinally movable manner, the screw-fastening being prestressed over only one part of the total possible spring travel thereof.

The torque support according to the invention is, according to a further, particularly preferred embodiment, characterised in that at least one fixing unit at least partially forms a segment of the connecting element.

According to a further, particularly preferred embodiment, the connecting element of the torque support according to the invention has three segments and/or at least two coupling regions between the segments.

According to a further, particularly preferred embodiment of the torque support according to the invention, the segments are guided by means of leaf springs, in particular prestressed leaf springs.

According to a further, particularly preferred embodiment of the torque support according to the invention, the motor is designed as a direct drive for receiving drive shafts up to a diameter of 300 mm, in particular for a diameter between 100 mm and 300 mm and preferably for 125 mm, 150 mm, 175 mm, 200 mm, 225 mm, 250 mm and/or 275 mm.

According to a further, particularly preferred embodiment of the torque support according to the invention, the motor makes it possible for a steam head with at least one hollow shaft to be incorporated and attached. A “steam head” according to the present invention means in particular a rotary joint for connecting pressure systems to the correspondingly produced elements such as a heating roller.

According to a further, particularly preferred embodiment of the torque support according to the invention, thermal insulation is provided between the steam head or the hollow shaft and the motor. This is important in particular for mounting on dry systems such as dry cylinders. Steam of up to 200° C. is conducted through the hollow shaft to the cylinder. To this is added the heat given off by the electromotive drive itself. In order that the electronic components are not adversely affected during continuous operation, they should only be exposed to 120° C., it being possible to reduce the thermal load by means of the thermal decoupling. Where necessary, further devices, in particular cooling units or apparatus for the drive itself should be provided.

According to a further, particularly preferred embodiment of the torque support according to the invention, a bearing cover is provided in the region of the hollow shaft. The bearing cover is used in this case as an additional support for the steam head on the shaft when used with a steam head, in particular within the meaning of the present invention.

The present invention further comprises the use of the torque support according to the invention for the drive of cylinders, rollers and the like in a paper machine, printing machine, rolling mills and the like.

The invention is explained below using preferred exemplary embodiments; it is pointed out that modifications or additions such as are directly suggested to a person skilled in the art are included by these examples. Furthermore, these preferred exemplary embodiments are not limitations of the invention, so modifications and additions also lie within the scope of the present invention.

In the figures:

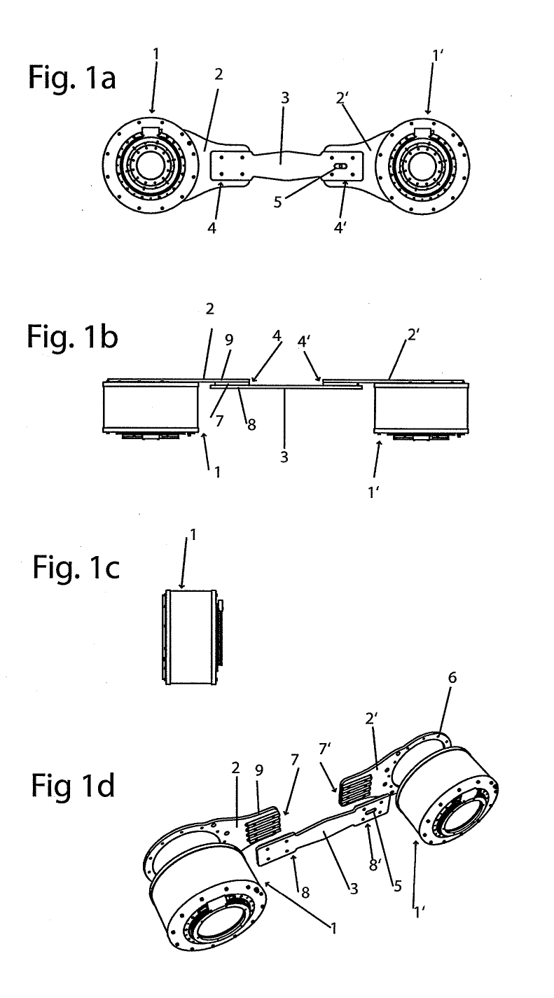

FIG. 1 shows the coupling of two motors by means of a segmented connector from different perspectives (a, b, c) and a partial exploded diagram (d) according to the present invention;

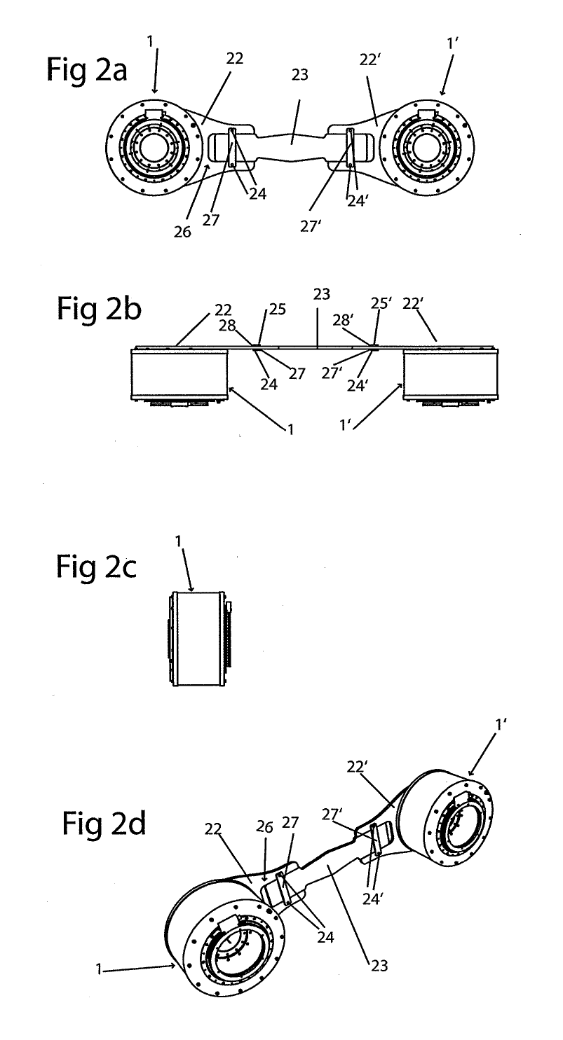

FIG. 2 shows a further system consisting of three component parts with machined contact faces and four leaf spring components from different perspectives (a, b, c) and a partial exploded diagram (d) according to the present invention;

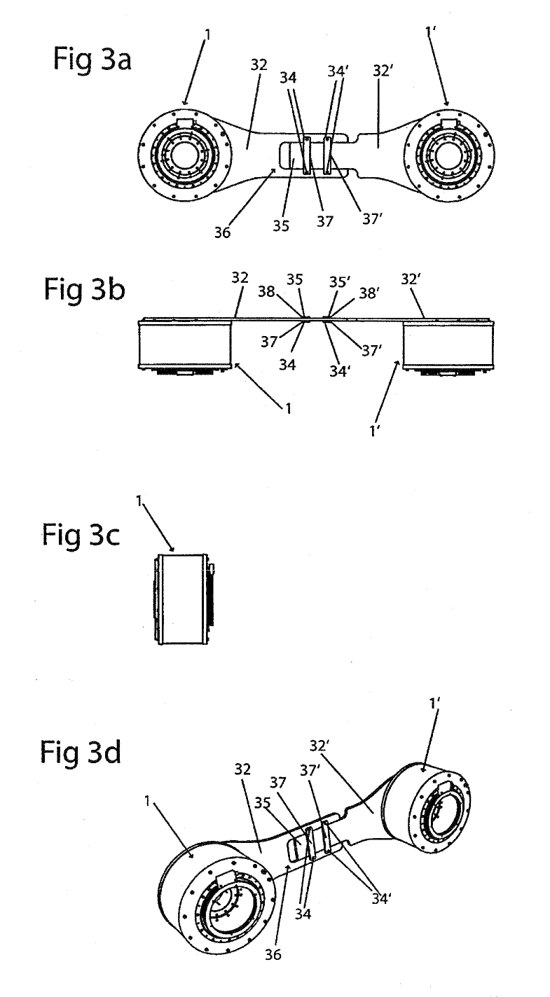

FIG. 3 shows a further system with reduced components from different perspectives (a, b, c) and a partial exploded diagram (d) according to the present invention;

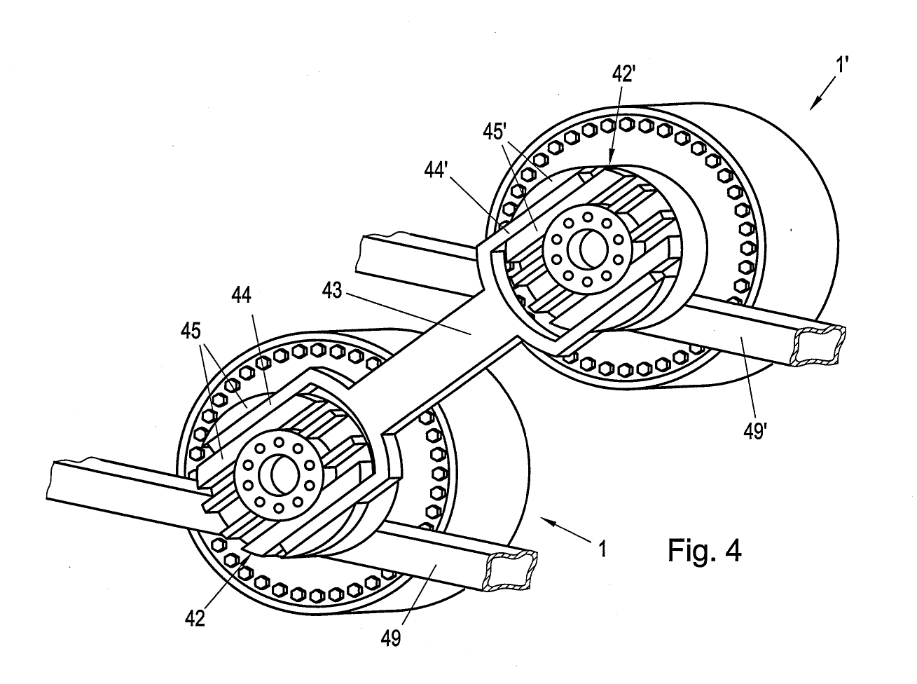

FIG. 4 shows the coupling of two motors by means of an alternative segmented connector.

The exemplary embodiment according to FIG. 1 shows the coupling of two motors 1, 1′ by means of a connecting element 3 between the first and second fixing units 2, 2′ which are each mounted in a non-rotatable manner on the motors 1, 1′. The fixing units 2, 2′ are screw-fastened at the end to the housing of the motor using corresponding bores 6. The connecting element 3 is connected in the coupling regions 4, 4′ by means of the segments 7, 7′ which are configured as sliding clutch. In the process the sliding coupling forms tongue and groove connections which engage in each other. The connecting element 3 further has a guide 5 in the coupling region 4 in order to hold the components which are movable in a longitudinal, tilting and/or torsional manner in position.

The exemplary embodiment according to FIG. 2 is an alternative system to the embodiment of FIG. 1. The fixing units 22, 22′ are connected at the end in a non-rotatable manner to the housing of the motors 1, 1′. The fixing units 22, 22′ have a receiving region 26 which receives the ends of the connecting element 23 and thus forms a coupling region. The connecting element 23 is held on both sides by means of leaf spring components 27, 27′, 28, 28′, which are connected to the fixing units 22, 22′ by means of suitable fixing means such as screw-fastenings 24, 24′, 25, 25′. A connection which can be telescoped and is suitable for compensating distance differences is created in this manner between the connecting element 23 and the fixing elements 22, 22′. The modular system allows simple mounting and maintenance and simple replacement of individual components. The connecting element can thus be inserted and fixed simply after mounting of the fixing elements with the leaf spring components.

The exemplary embodiment according to FIG. 3 is an alternative configuration of the system of FIG. 2. The fixing elements 32, 32′ are in this case configured differently. One fixing element 32 has a receiving region 36, the other fixing element 32′ comprising the connecting member 35. Both fixing elements are connected at the end and in a non-rotatable manner to the housings of the motors 1, 1′. The receiving region 36 of the fixing element 32 comprises the connecting member 35 of the fixing element 32′. The leaf spring components 37, 37′, 38, 38′ are fixed to the fixing element 32 by suitable fixing means such as screw-fastenings 34, 34′, 35, 35′.

The exemplary embodiment according to FIG. 4 shows a further example for fixing elements 42, 42′, which are connected at the end in a non-rotatable manner to the motors 1, 1′. The motors 1, 1′ are suspended on carriers 49, 49′ of the system. The ends of the connecting element 43 are in this case fork-shaped, so they engage between the segments 45, 45′ of the fixing elements 42, 42′ and thus form the coupling unit with them. The fork-shaped ends 44, 44′ of the connecting element 43 in the process provide both longitudinal displacement and tilting movement by accommodation in the segments of the fixing elements 45, 45′. Torsional movement is produced by the possibility of twisting the connecting element 43 between the forks 44 and 44′. According to a further, preferred embodiment, the connecting element can also have a closed configuration.

1. Torque support for drive motors, consisting of a system having at least one first and second fixing element for non-rotatable mounting on at least one first and one second drive motor (1, 1′) and at least one connecting element (3, 23) between the first and second fixing elements (2, 2′, 22, 22′, 32, 32′, 42, 42′), characterised in that the system has a modular construction and the connecting element (3, 23) which can be replaced by the first and second fixing elements can be moved at least in its longitudinal direction in order to compensate distance difference between the drive motors (1, 1′) and provides a spherical compensation of movement with at least one coupling region (4, 4′) with the first and/or second fixing element (2, 2′, 22, 22′, 32, 32′, 42, 42′).

2. Torque support according to claim 1, characterised in that the connecting element (3, 23) can be moved in a tilting and/or torsional manner.

3. Torque support according to claim 2, characterised in that the fixing element(2, 2′, 22, 22′, 32, 32′, 42, 42′) and/or the connecting element (3, 23) are arranged such that they can move in a tilting manner.

4. Torque support according to claim 3, characterised in that the tilting movement is effected by a hinge, a clutch, an articulation, combinations thereof or the like.

5. Torque support according to claim 4, characterised in that the connecting element (3, 23) is segmented and the segments are connected by means of a coupling region (4, 4′).

6. Torque support according to claim 5, characterised in that the coupling region has a connector and a receiving region (26, 36) and the connector is mounted in the receiving region (26, 36) in a longitudinally displaceable and/or rotationally movable manner and can in particular be telescoped.

7. Torque support according to claim 5, characterised in that the coupling regions (4, 4′) are configured as a sliding clutch between at least one first and one second segment of the connecting element (3, 23).

8. Torque support according to claim 7, characterised in that the sliding clutch is provided between the segments of the connecting element (3, 23) by means of at least one longitudinally displaceable tongue and groove connection.

9. Torque support according to claim 8, characterised in that the depth of the groove receiving the tongue is greater than that of the tongues.

10. Torque support according to claim 8, characterised in that a profile in arranged in the groove in a replaceable manner, which for its part has a groove which directly receives the tongue.

11. Torque support according to claim 1, characterised in that the second fixing element (2, 2′, 22, 22′, 32, 32′, 42, 42′) is connected to the housing of the motor (1, 1′) in a form-fitting and/or force-fitting and/or materially and is in particular screw-fastened to it.

12. Torque support according to claim 1, characterised in that the at least one fixing unit element (2, 2′, 22, 22′, 32, 32′, 42, 42′) is arranged on an end face of the motor (1, 1′) and is in particular configured as a fixing ring.

13. Torque support according to claim 1, characterised in that a spring-elastic spacer element is provided around a section of the screw-fastening, which spacer element is prestressed by the screw-fastening over only one part of the total possible spring travel thereof.

14. Torque support according to claim 1, characterised in that the at least one fixing element (32, 32′) also forms at least one segment of the connecting element (35).

15. Torque support according to claim 1, characterised in that the connecting element (3, 23) has three segments and/or at least two coupling regions (4, 4′) are provided between the segments.

16. Torque support according to claim 7, characterised in that the guiding of the segments is effected by means of leaf springs (24, 24′, 25, 25′, 34, 34′, 35, 35′), in particular prestressed leaf springs.

17. Torque support according to claim 1, characterised in that the motor (1, 1′) is designed as a direct drive for receiving drive shafts up to a diameter of 300 mm, in particular for a diameter between 100 mm and 300 mm and preferably for 125 mm, 150 mm, 175 mm, 200 mm, 225 mm, 250 mm and/or 275 mm.

18. Torque support according to claim 1, characterised in that the motor allows a steam head with at least one hollow shaft to be incorporated and attached.

19. Torque support according to claim 18, characterised in that thermal insulation is provided between the steam head or the hollow shaft and the motor (1, 1′).

20. Torque support according to claim 18, characterised in that a bearing cover is arranged in the region of the hollow shaft.

21. Use of the torque support according to claim 1 for the drive of cylinders, rollers and the like in a paper machine, printing machine, rolling mills and the like.
